(19) United States
(12) Patent Application Publication
(10) Pub. No.: US 2011/0170040 A1
(43) Pub. Date: Jul. 14, 2011

(54) LIQUID CRYSTAL DISPLAY

(75) Inventors: Jae Hong Park, Hwaseong-si (KR); Ohjeong Kwon, Hwaseong-si (KR); Sung-Jae Yun, Yongin-si (KR); Hong-Jo Park, Asan-si (KR); Hyeokjin Lee, Seongnam-si (KR); Soon Joon Rho, Suwon-si (KR); Sung Hwan Hong, Suwon-si (KR); Jae-Soo Jang, Suwon-si (KR); Heeseop Kim, Hwaseong-si (KR); Sung-Hwan Hong, Incheon (KR); Byung-Chul Kim, Yongin-si (KR)

(73) Assignee: Samsung Electronics Co., Ltd., Suwon-si (KR)

(21) Appl. No.: 12/817,536

(22) Filed: Jun. 17, 2010

(30) Foreign Application Priority Data
Jan. 13, 2010 (KR) 10-2010-0003204

(51) Int. Cl. G02F 1/1333; G02F 1/1335

(52) U.S. Cl. 349/96; 349/167; 349/113

(57) ABSTRACT

A liquid crystal display includes a liquid crystal display panel and a phase difference plate. The liquid crystal display panel includes an array substrate provided therein with pixel areas to display an image, an opposite substrate which faces the array substrate, and a blue-phase liquid crystal which is interposed between the array substrate and the opposite substrate. A reflective peak wavelength indicated by the peak reflectance of the blue-phase liquid crystal is positioned in the wavelength band of a visible light. The phase difference plate is provided above or below the liquid crystal display panel. The driving voltage and the memory ratio of the blue-phase liquid crystal are reduced, and the light leakage caused by a visible light selectively reflected by the blue-phase liquid crystal can be prevented.

### CROSS-REFERENCE TO RELATED APPLICATION

This application claims priority to and benefit of Korean Patent Application No. 10-2010-0003204, filed on Jan. 13, 2010, which is herein incorporated by reference for all purposes as if fully set forth herein.

### BACKGROUND OF THE INVENTION

1. Field of the Invention

Exemplary embodiments of the present invention relate to a liquid crystal display, more particularly, to a liquid crystal display capable of displaying an image by using a blue-phase liquid crystal.

2. Description of the Related Art

In general, a liquid crystal display panel may include two substrates facing each is other and liquid crystals interposed between the two substrates. Directors of the liquid crystals can be controlled by using an electric field between two electrodes respectively formed on the two substrates.

The liquid crystal display panel may receive a light from an external light source. The transmittance of a light passing through the two substrates can be changed by the liquid crystals. However, liquid crystals arranged in a specific direction may cause the liquid crystal display panel with narrower viewing angles than those of other types of display apparatuses, and uniformity of a cell gap distance between two substrates may adversely affect angle viewing quality of the liquid crystal display panel.

In order to prevent degrading the viewing angle quality by the uniform cell gap distance, an approach has been introduced to make a liquid crystal display panel utilizing blue-phase liquid crystals. However, this approach requires a high driving voltage due to its driving characteristic.

### SUMMARY OF THE INVENTION

Exemplary embodiments of the prevent invention provide a liquid crystal display capable of reducing a driving voltage of a blue-phase liquid crystal to improve display quality.

Additional features of the invention will be set forth in the description which follows, and in part will be apparent from the description, or may be learned by practice of the invention.

Exemplary embodiments of the present invention provide a liquid crystal display. The liquid crystal display includes a first substrate comprising pixel areas to display an image, a second substrate facing the first substrate, and a blue-phase liquid crystal interposed between the is first substrate and the second substrate to selectively reflect a light having a wavelength range of about 400 nm to about 700 nm. The liquid crystal display also includes a phase difference plate which is provided above, below, or both above and below of the blue-phase liquid crystal.

Exemplary embodiments of the present invention provide a display. The display includes a plurality of pixels provided on a first substrate facing a second substrate. A blue-phase liquid crystal interposed between the first substrate and the second substrate. The blue-phase liquid crystal has a peak reflectance wavelength in a visible wavelength range about 400 nm to about 700 nm to selectively reflect a light incident via a top surface of the second substrate

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a sectional view showing a liquid crystal display panel according to exemplary embodiments of the present invention.

FIG. 2 is a diagram showing a structure of a blue-phase liquid crystal.

FIG. 3 is a graph showing the types of the blue-phase liquid crystal with respect to a temperature range and a chiral nematic phase.

FIG. 4 is a perspective view showing a first blue-phase liquid crystal of FIG. 3.

FIG. 5 is a diagram showing an on-state of the liquid crystal display panel of FIG. 1.

FIG. 6 is a diagram showing an exemplary structure of a blue-phase liquid crystal aligned by an electric field.

FIG. 7 is a graph showing reflectance as a function of a wavelength of the blue-phase liquid crystal according to exemplary embodiments of the present invention.

FIG. 8 is a diagram showing a cube defined by the blue-phase liquid crystal.

FIG. 9 is a graph showing an exemplary magnitude of a driving voltage as a function of a pitch of the blue-phase liquid crystal.

FIG. 10 is a graph showing an exemplary memory ratio as a function of a reflective peak wavelength.

FIG. 11 is a sectional view of a transmissive LCD according to exemplary embodiments of the present invention.

FIG. 12 is a plan view showing an array substrate of FIG. 11.

FIG. 13A is a plan view showing the relationship of a first polarizing plate, a first λ/4 plate, a second λ/4 plate, and a second polarizing plate of FIG. 11.

FIG. 13B is a diagram showing the light polarization variation in the transmissive LCD of FIG. 11.

FIG. 14 is a sectional view showing a reflective LCD according to exemplary embodiments of the present invention.

FIG. 15 is a sectional view showing the light polarization variation in the reflective LCD of FIG. 14.

FIG. 16 is a sectional view showing a transflective LCD according to exemplary is embodiments of the present invention.

FIG. 17 is a sectional view showing a reflective LCD according to exemplary embodiments of the present invention.

FIG. 18 is a graph showing a reflective peak wavelength as a function of an amount of chiral dopants.

FIG. 19 is a graph showing driving voltages according to the case A, the case B and the case C of FIG. 18.

FIG. 20 is a graph showing a memory ratio according to the case A, the case B and the case C of FIG. 18.

### DESCRIPTION OF THE ILLUSTRATED EMBODIMENTS

Hereinafter, exemplary embodiments of the present invention are described in more detail with reference to accompanying drawings.

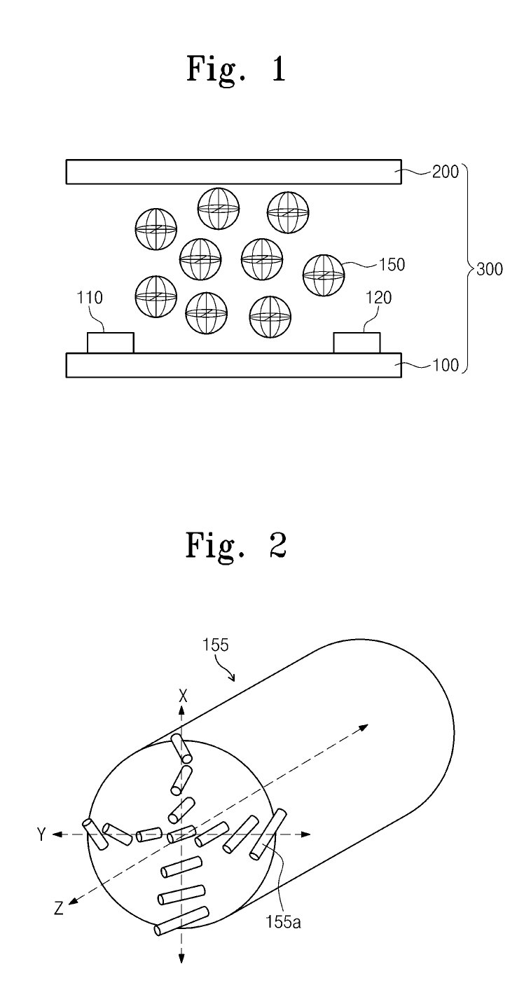

FIG. 1 is a sectional view showing a liquid crystal display panel according to exemplary embodiments of the present invention, and FIG. 2 is a diagram showing a structure of blue-phase liquid crystals.

Referring to FIG. 1 and FIG. 2, a liquid crystal display panel 300 may include an array substrate 100, an opposite substrate 200, and a blue-phase liquid crystals 150 interposed between the array substrate 100 and the opposite substrate 200.

The array substrate 100 may include a first pixel electrode 110 and a second pixel electrode 120 spaced apart from each other with a distance. For example, the first pixel electrode 110 can receive a first driving voltage, and the second pixel electrode 120 can receive a second driving voltage. Therefore, an electric field may be formed between the first pixel electrode 110 and the second pixel electrode 120 due to the difference between the first driving voltage and the second driving voltage.

FIG. 1 shows the liquid crystal display panel 300 operated at a normally black mode and, for example, may show an off-state in which the first driving voltage and the second driving voltage may not be applied to the first pixel electrode 110 and the second pixel electrode 120.

Since liquid crystal directors 155a are aligned in a double spiral structure, the blue-phase liquid crystal 150 may include liquid crystal molecules constructing the structure of a double twist cylinder (DTC) 155. As shown in FIG. 2, the liquid crystal directors 155a are twisted along two axes (that is, X and Y axes) substantially perpendicular to each other in the DTC 155. For example, the liquid crystal directors 155a are more strongly twisted from a central axis (Z axis) toward an outer portion of the DTC 155. As described above, the blue-phase liquid crystals 150 may have a direction with respect to the central axis of the DTC 155 within the DTC 155.

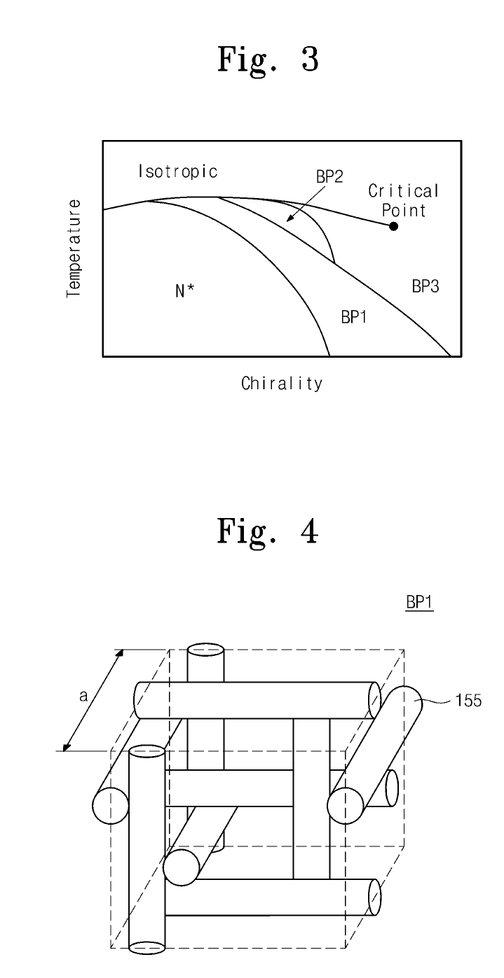

FIG. 3 is a graph showing the types of a blue-phase liquid crystal with respect to a temperature range and a chiral nematic phase, and FIG. 4 is a perspective view showing a first blue-phase liquid crystal BP1 of FIG. 3. As shown in FIG. 3, an X axis represents an amount of chiral dopants (i.e., chirality), and a Y axis represents a temperature.

Referring to FIG. 3, the blue-phase liquid crystal 150 appears in an area having a temperature of a few ° C. between a chiral nematic phase and an isotropic phase. The blue-phase liquid crystal 150 may include the first blue-phase liquid crystal BP1, the second blue-phase liquid crystal BP2, and the third blue-phase liquid crystal BP3, and the double-twisted cylinder (DTC) 155 may have various arrangement structures according to the types of the blue-phase is liquid crystal 150.

The blue-phase liquid crystal BP1 among the first blue-phase liquid crystal BP1, the second blue-phase liquid crystal BP2, and the third blue-phase liquid crystal BP3 may have a temperature range wider than those of the other blue-phase liquid crystals, for example, BP2 and BP3. Accordingly, the blue-phase liquid crystal BP1 can be more suitable for commercialization when comparing with the second blue-phase liquid crystal BP2 and the third blue-phase liquid crystal BP3.

As shown in FIG. 4, the first blue-phase liquid crystal BP1 is arranged in a body-centered cubic lattice structure that is one of lattice structures of the DTC 155. Hereinafter, a side of a cube having the body-centered cubic lattice structure may be referred to as a pitch of the blue-phase liquid crystal 150.

For example, as shown in FIG. 1, the blue-phase liquid crystal 150 may include the first blue-phase liquid crystal BP1. In some examples, the blue-phase liquid crystal 150 may include a polymer-stabilized blue-phase liquid crystal stabilized through the coupling with a polymer. The polymer-stabilized blue-phase liquid crystal may include the mixture of a polymer so that the lattice structure of the DCT 155 can be stabilized. For example, if a polymer is mixed with the blue-phase liquid crystal, the polymer is more strongly combined with liquid crystals of the DTC 155, thereby liquid crystals may have no directionality. Accordingly, the lattice structure of the DTC 155 can be stabilized, and the temperature range, in which the blue-phase liquid crystal 150 appears, may be expanded from a range of about 1° C. to about 5° C. to a range of about 6° C. or less.

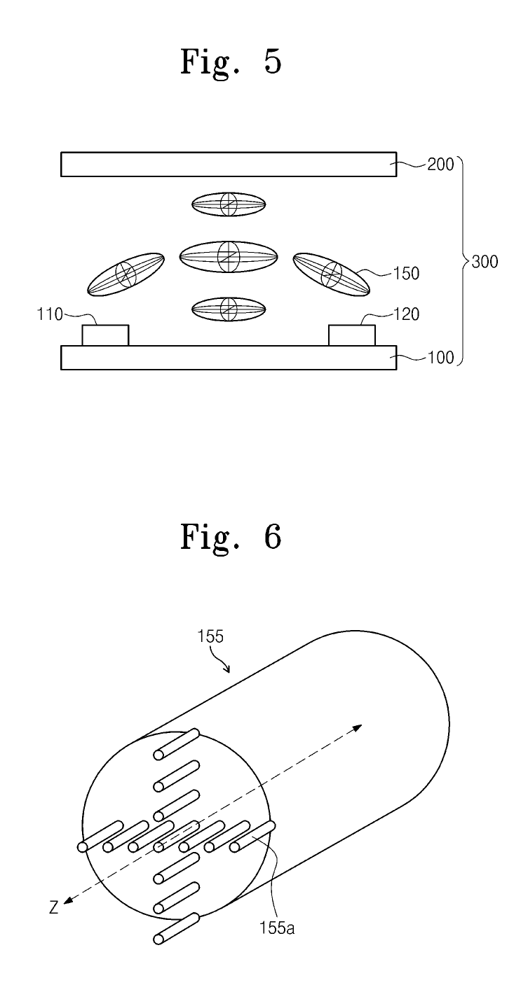

FIG. 5 is a diagram showing an on state of the liquid crystal display panel of FIG. 1, and FIG. 6 is a diagram showing an exemplary structure of a blue-phase liquid crystal 150 is aligned by an electric field.

Referring to FIG. 5 and FIG. 6, if the first and second driving voltages are applied to the first and second pixel electrodes 110 and 120 of the liquid crystal display panel 300, a horizontal electric field may be formed between the first and second pixel electrodes 110 and 120 so that the blue-phase liquid crystal 150 may be aligned between the array substrate 100 and the opposite substrate 200.

As shown in FIG. 6, the liquid crystal directors 155a are aligned in parallel to the central axis (Z axis) of the DTC 155 by the electric field. Accordingly, the liquid crystal display panel 300 can transmit an external light.

For example, the anisotropic refractive index of the blue-phase liquid crystal 150 may be changed proportionally to the square of the driving voltage of the blue-phase liquid crystal 150 (that is, the potential difference between the first and second driving voltages). As described above, when an electric field is applied to an isotropic polarity material, a refractive index can be increased proportionally to the square of the applied voltage, known as “Kerr effect”. The liquid crystal display panel 300 (see FIG. 1) displays an image based on Kerr effect of the blue-phase liquid crystal 150 (see FIG. 2). Accordingly, the response speed of the liquid crystal display panel 300 can be improved.

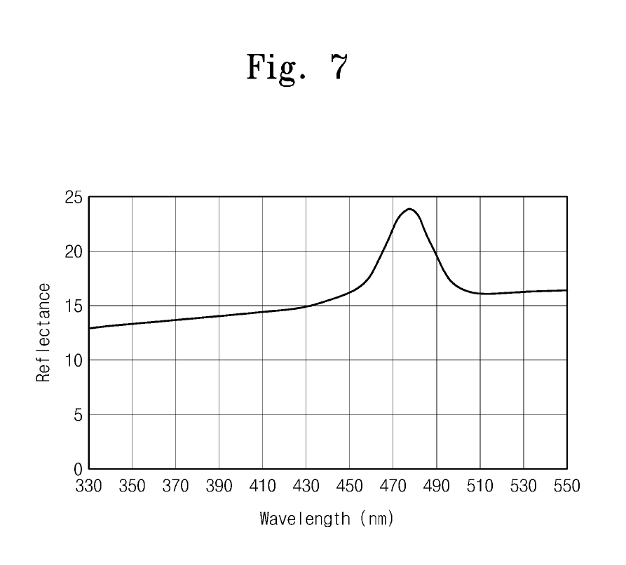

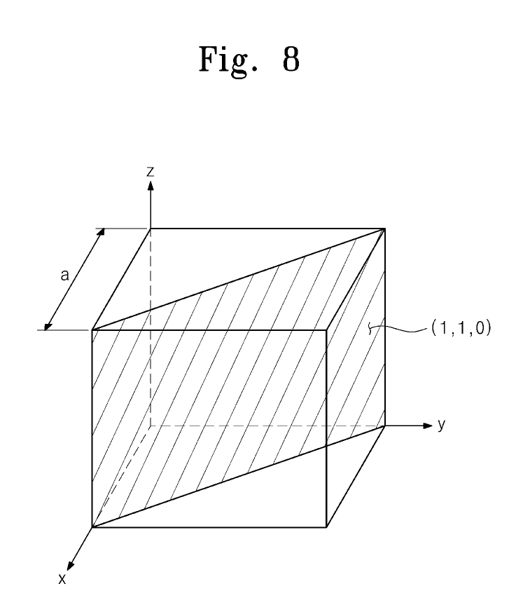

FIG. 7 is a graph showing reflectance as a function of a wavelength of the blue-phase liquid crystal 150 according to exemplary embodiments of the present invention. FIG. 8 is a diagram showing a cube defined by the blue-phase liquid crystal 150. In FIG. 7, an X axis represents a wavelength (nm), and a Y axis represents reflectance.

Referring to FIG. 7, the blue-phase liquid crystal 150 may selectively reflect light having a wavelength range of about 400 nm to about 700 nm. Particularly, a reflective peak is wavelength (λpeak), at which the blue-phase liquid crystal 150 represents the maximum reflectance, may be positioned in the wavelength range (that is, the wavelength range of visible light) of about 450 nm to about 550 nm.

The reflective peak wavelength (λpeak) may be defined by Equation 1:

$$λ peak = \frac{2 na}{\sqrt{{h}^{2} + {k}^{2} + {l}^{2}}}$$

In Equation 1, ‘n’ represents an average refractive index of the blue-phase liquid crystal 150, and ‘a’ represents a pitch of the blue-phase liquid crystal 150. In addition, ‘h,’ ‘k,’ and ‘l’ represent three integers belonging to miller indexes when each plane of a cube defined by the blue-phase liquid crystal 150 is expressed as the miller indexes.

Referring to FIG. 8, the cube may be defined by the blue-phase liquid crystal 150 having a body-centered cubic lattice structure. Each side of the cube may be defined as the pitch a of the blue-phase liquid crystal 150. Each plane of the cube can be expressed by the miller indexes. Especially, a first plane linking two facing sides with each other while being spaced apart from a Z axis can make a greater influence on determining the reflective peak wavelength (λpeak) of the blue-phase liquid crystal 150 than the other planes. The first plane can be represented as miller indexes (1, 1, 0). In other words, the ‘h,’ ‘k,’ and ‘l’ may be represented as ‘1,’ ‘1,’ and ‘0,’ respectively.

If the average refractive index of the blue-phase liquid crystal 150 is about 1.5, the reflective peak wavelength (λpeak) is in the wavelength range of about 450 nm to about 550 nm, and the ‘h,’ ‘k,’ and ‘l’ are ‘1,’ ‘1,’ and ‘0,’ respectively, the pitch a of the blue-phase liquid crystal 150 can be calculated by Equation 1. In some examples, the pitch a of the blue-phase is liquid crystal 150 may be in the range of about 210 nm to about 260 nm.

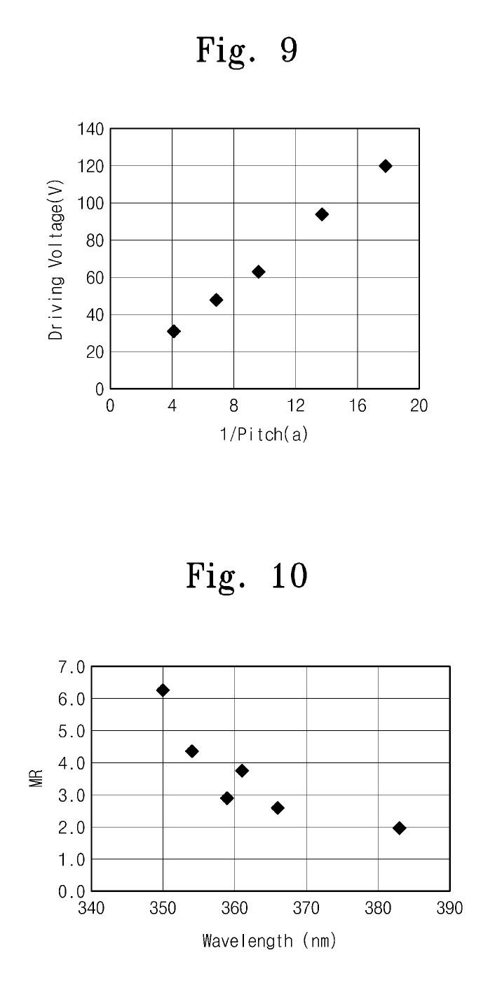

FIG. 9 is a graph showing an exemplary magnitude of a driving voltage as a function of the pitch of the blue-phase liquid crystal 150, and FIG. 10 is a graph showing an exemplary memory ratio as a function of a wavelength. In FIG. 9, an X axis represents 1/(the pitch a of the blue-phase liquid crystal 150), and a Y axis represents a driving voltage V. In FIG. 10, an X axis represents a reflective peak wavelength (λpeak), and an Y axis represents a memory ratio.

Referring to FIG. 9, as the pitch a of the blue-phase liquid crystal 150 is reduced, the driving voltage (which is defined by the potential difference of the first and second driving voltages applied to the first and second pixel electrodes 110 and 120, respectively) of the blue-phase liquid crystal 150 is increased.

In Equation 1, the pitch of the blue-phase liquid crystal 150 is proportional to the reflective peak wavelength (λpeak) of the blue-phase liquid crystal 150.

Accordingly, if the reflective peak wavelength (λpeak) of the blue-phase liquid crystal 150 is shifted into a wavelength range (e.g., about 450 nm to about 550 nm) of visible light, the pitch of the blue-phase liquid crystal 150 may be increased, but the driving voltage may be decreased. Accordingly, when the reflective peak wavelength (λpeak) of the blue-phase liquid crystal 150 is increased, the driving voltage of the blue-phase liquid crystal 150 may be decreased.

Referring to FIG. 10, as the reflective peak wavelength (λpeak) is decreased, the memory ratio MR is decreased. For example, the memory ratio MR can be defined as a value obtained by dividing black brightness, which is represented after the driving of the liquid crystal display panel 300, by black brightness which is represented before the initial driving of the liquid is crystal display panel 300. Therefore, as the memory ratio MR approximates 1, the display characteristic of the liquid crystal display panel 300 may be improved.

As shown in FIG. 10, as the reflective peak wavelength (λpeak) is increased, the memory ratio MR, for example, may be approximately 1.

As described above, if the reflective peak wavelength (λpeak) of the blue-phase liquid crystal 150 is shifted into the wavelength range of visible light, light leakage may occur in the liquid crystal display panel 300. The description of an LCD capable of preventing light leakage is described in detail below.

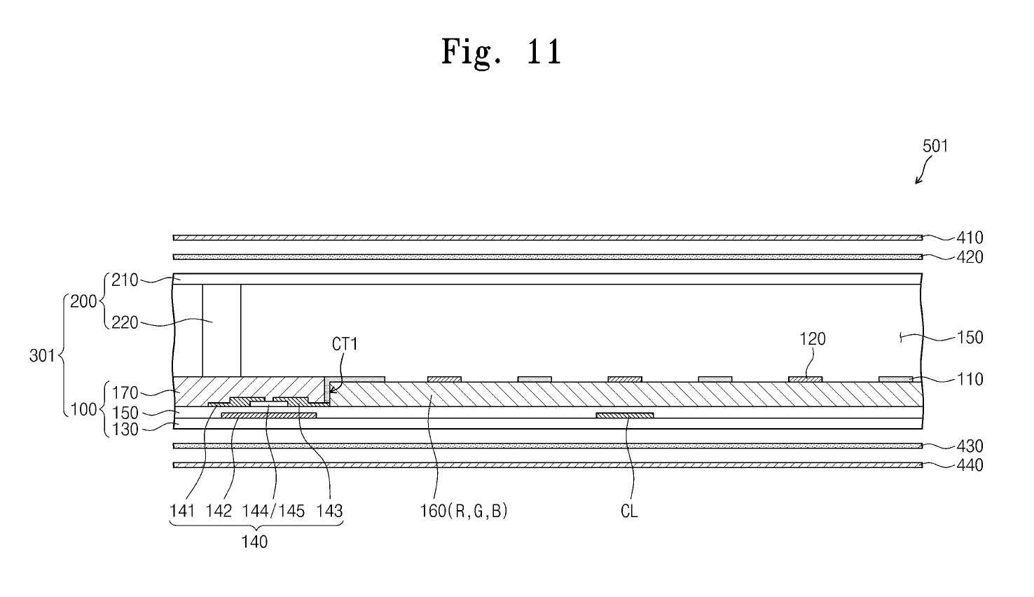

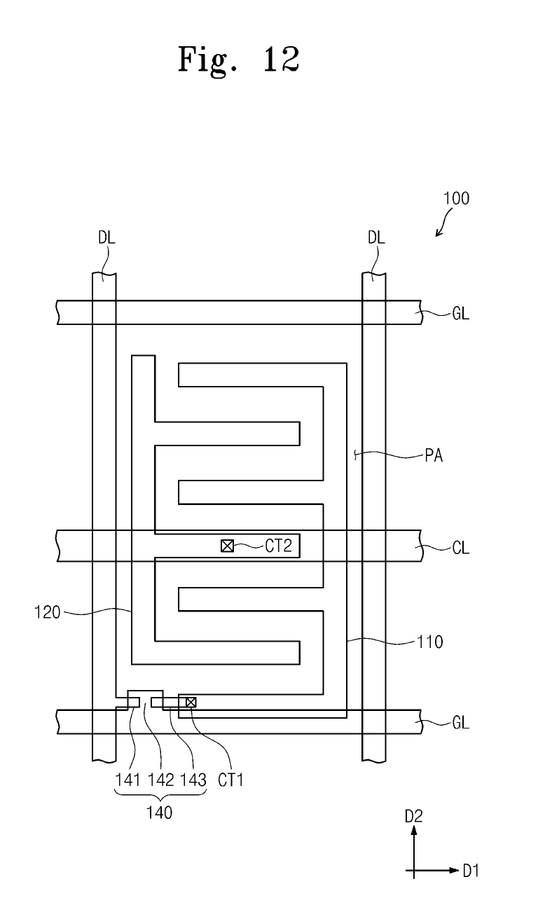

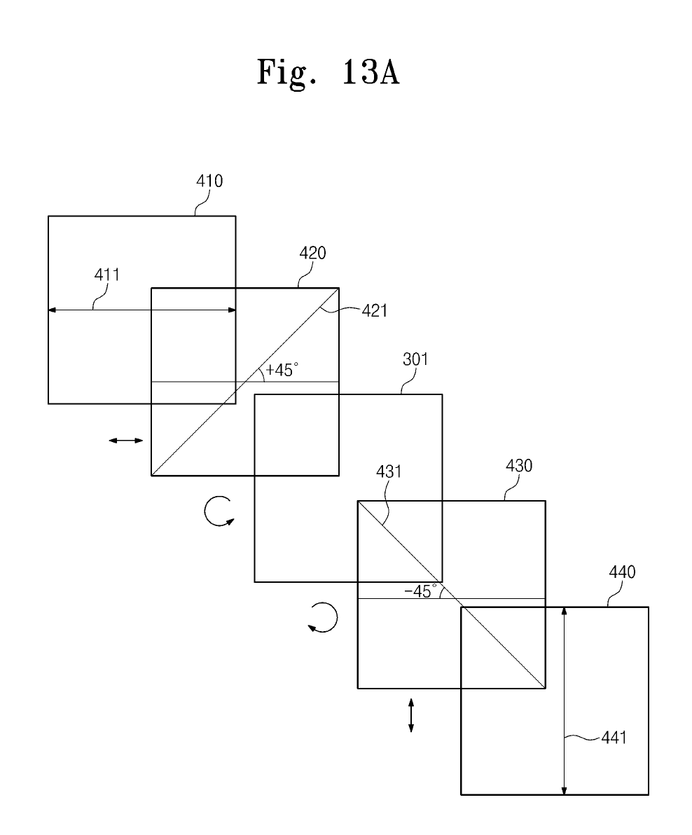

FIG. 11 is a sectional view of a transmissive LCD 501 according to exemplary embodiments of the present invention, and FIG. 12 is a plan view showing the array substrate 100 of FIG. 11.

Referring to FIG. 11, the transmissive LCD 501 may include a transmissive liquid crystal display panel 301, a first polarizing plate 410, a first phase difference plate 420 (hereinafter, referred to as first λ/4 plate), a second phase difference plate 430 (hereinafter, referred to as second λ/4 plate), and a second polarizing plate 440.

For example, the transmissive liquid crystal display panel 301 may include the array substrate 100, the opposite substrate 200 facing the array substrate 100, and the blue-phase liquid crystal 150 interposed between the array substrate 100 and the opposite substrate 200.

The array substrate 100 may include a first base substrate 130 and a plurality of pixels provided on the first base substrate 130. Although a sectional structure for only one pixel is representatively depicted in FIG. 11 for the purpose of explanation, remaining pixels may have the same sectional structure as that of the represented pixel.

Each pixel may include a thin film transistor 140 and the first pixel electrode 110 and the second pixel electrode 120.

Referring to FIG. 12, a pixel area PA is defined on the first base substrate 130 by a gate line GL extending in a first direction D1 and a data line DL extending in a second direction D2 while crossing the gate line GL.

In some examples, the first thin film transistor 140 may be provided in the pixel area PA to switch the first driving voltage applied to the first pixel electrode 110. For example, the first thin film transistor 140 may include a source electrode 141 branching from the data line DL, a gate electrode 142 branching from the gate line GL, and a drain electrode 143 spaced apart from the source electrode 141 with a distance.

As shown in FIG. 11, the gate electrode 142 may be covered with a gate insulating layer 150, and an active layer 144 and an ohmic-contact layer 145 may be interposed between the gate insulating layer 150 and the source and drain electrodes 141 and 143.

The thin film transistor 140 may be covered with a black matrix layer 170, and one color filter 160 selected from red, green, and blue filters R, G, and B may be formed at a remaining portion of the pixel area PA, in which the thin film transistor 140 may not be formed.

The first and second pixel electrodes 110 and 120 may be formed on the color filter 160. The first and second pixel electrodes 110 and 120 may include a transparent conductive material such as indium tin oxide (ITO) or indium zinc oxide (IZO).

The black matrix layer 170 may be provided therein with a first contact hole CT1 to expose the drain electrode 143. The first pixel electrode 110 may be coupled with the drain electrode 143 via the first contact hole CT1 to receive the first driving voltage from the drain electrode 143.

For example, the second pixel electrode 120 may alternately be aligned with the is first pixel electrode 110 on the color filter 160. The first pixel electrode 120 may have a width substantially identical to that of the second pixel electrode 110. The first and second pixel electrodes 110 and 120 adjacent to each other in the first and second directions D1 and D2 may be spaced apart from each other with the same interval.

The pixel area PA may further include a storage line CL extending in the first direction D1 in parallel to the gate line GL. The storage line CL can receive the second driving voltage from an outside.

The color filter 160 may be provided therein with a second contact hole CT2 to expose the storage line CL. Accordingly, the second pixel electrode 120 may be coupled with the storage line CL through the second contact hole CT2 to receive the second driving voltage from the storage line CL.

An electric field may be formed between the first and second pixel electrodes 110 and 120 having the above structure.

In some examples, the opposite substrate 200 may include a second base substrate 210 and a column spacer 220 provided on the second base substrate 210. The second base substrate 210 may face the first base substrate 130, and the column spacer 220 may be interposed between the first and second substrates 130 and 210 so that the interval between the first and second substrates 130 and 210 may constantly be maintained. For example, the column spacer 220 may be provided corresponding to the area in which the black matrix layer 170 is formed. Accordingly, an aperture ratio may be prevented from being reduced by the column spacer 220.

The blue-phase liquid crystal 150 may be interposed between the first base substrate 130 and the second base substrate 210 spaced apart from each other with a distance by the column spacer 220. For example, the blue-phase liquid crystal 150 may have the reflective is peak wavelength (λpeak) in the wavelength range of about 450 nm to about 550 nm.

In order to remove light leakage caused by the blue-phase liquid crystal 150 having the reflective peak wavelength (λpeak) in the wavelength range of about 450 nm to about 550 nm, the first λ/4 plate 420 may be provided above the opposite substrate 200, and the second λ/4 plate 430 may be provided below the array substrate 100.

The first polarizing plate 410 may be provided above the first λ/4 plate 420, and the second polarizing plate 440 may be provided below the second λ/4 plate 430. Although not shown figures, the backlight of the transmissive LCD 501 may be provided below the second polarizing plate 440.

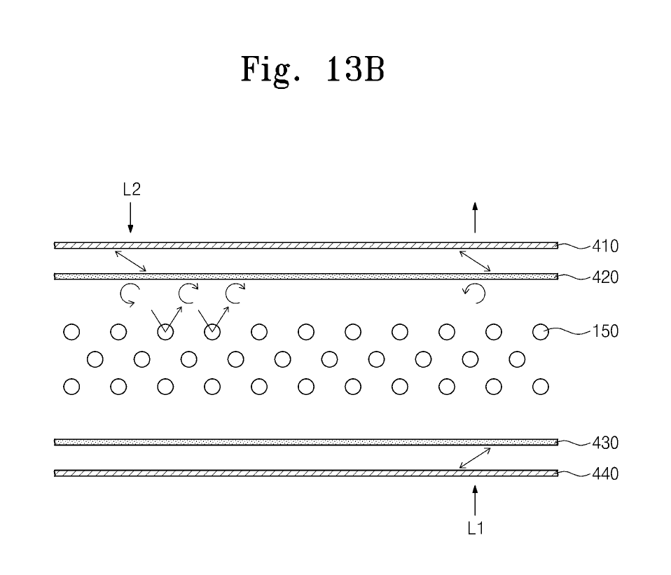

FIG. 13A is a plan view showing the relationship of the first polarizing plate 410, the first λ/4 plate 420, the second λ/4 plate 430, and the second polarizing plate 440 of FIG. 11, and FIG. 13B is a diagram showing the light polarization variation in the transmissive LCD 501 of FIG. 11.

Referring to FIG. 13A, each of the first polarizing plate 410 and the second polarizing plate 440 may include a transmission axis and an absorption axis. The first polarizing plate 410 and the second polarizing plate 440 may transmit only light oscillating along the transmission axis. The transmission axis is referred to as a first polarizing axis 411 of the first polarizing plate 410 or a second polarizing axis 441 of the second polarizing plate 440. For example, the first polarizing axis 411 of the first polarizing plate 410 may be orthogonal to the second polarizing axis 441 of the second polarizing late 440.

Each of the first λ/4 plate 420 and the second λ/4 plate 430 may have a slow axis having a higher refractive index of a light and a fast axis having a lower refractive index of a light. The first λ/4 plate 420 and second λ/4 plate 430 can convert a linear polarized light into a is circular polarized light, or can convert the circular polarized light into the linear polarized light. In this example, a slow axis 421 of the first λ/4 plate 420 is orthogonal to a slow axis 431 of the second λ/4 plate 430.

The first λ/4 plate 420 may have the slow axis 421 inclined from the first polarizing axis 411 of the first polarizing plate 410 at an angle of about +45°, and the second λ/4 plate 430 may have the slow axis 431 inclined from the first polarizing axis 411 of the first polarizing plate 410 at an angle of about −45°

Hereinafter, polarization variation of a light L1 emitted from a backlight provided below the liquid crystal display panel 301 and an external light L2 incident onto the liquid crystal display panel 301 through the opposite substrate 200 are described.

Referring to FIG. 13B, the first polarizing plate 410 can convert the external light L2 into a linear polarized light. The linear polarized light can be converted into a left circular polarized light by the first λ/4 plate 420, and the left circular polarized light can be converted into a right circular polarized light by the blue-phase liquid crystal 150 (see FIG. 11). Since the blue-phase liquid crystal 150 selectively reflects a light having the wavelength band of a visible light, a portion of the right circular polarized light can be incident onto the first λ/4 plate 420. However, the right circular polarized lights, which are incident onto the first λ/4 plate 420, do not pass through the first λ/4 plate 420, but are destructed. Accordingly, the light leakage caused by the external light L2 can be prevented.

However, the light L1 output from the backlight provided below the liquid crystal display panel 301 can be converted into a linear polarized light by the second polarizing plate 440. The linear polarized light can be converted into a right circular polarized light by the second λ/4 plate 430, and the right circular polarized light can be converted into a left circular is polarized light by the blue-phase liquid crystal 150. The left circular polarized light, which has passed through the blue-phase liquid crystal 150, can be incident onto the first λ/4 plate 420. The first λ/4 plate 420 can convert the left circular polarized light into the linear polarized light. The linear polarized light can be output to the outside through the first polarizing plate 410. Accordingly, the light L1 being output from the backlight can be viewed by a user.

Accordingly, the first λ/4 plate 420 and the second λ/4 plate 430 may be provided, thereby preventing light leakage due to the selective reflective characteristic of the blue-phase liquid crystal 150 in the transmissive LCD 501.

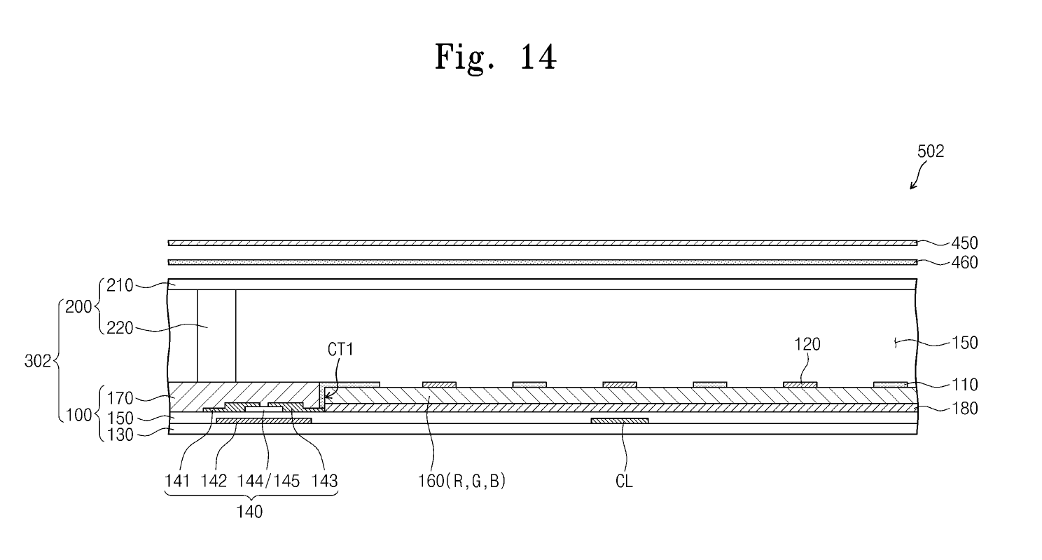

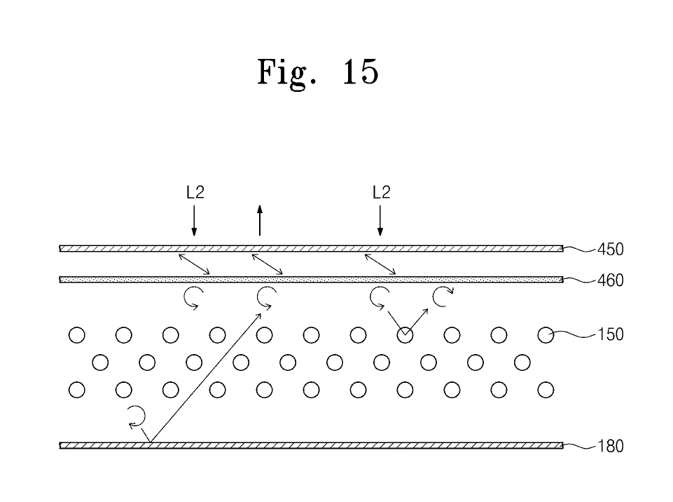

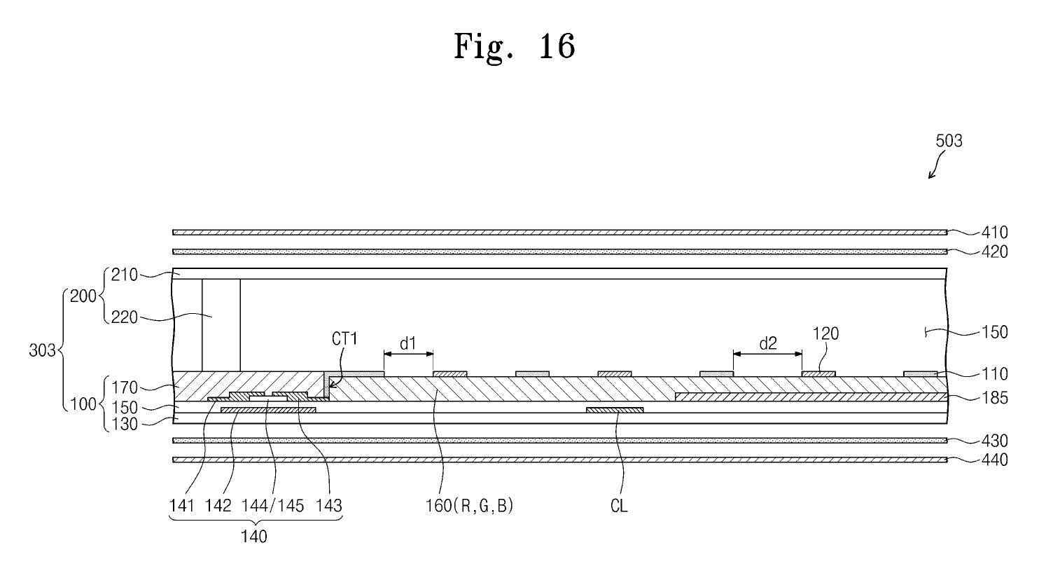

FIG. 14 is a sectional view showing a reflective LCD 502 according to exemplary embodiments of the present invention, and FIG. 15 is a sectional view showing the light polarization variation in the reflective LCD of FIG. 14. The same reference numerals will be assigned to elements of FIG. 14 identical to elements of FIG. 11, and details thereof may be omitted in order to avoid unnecessarily obscuring the invention.

Referring to FIG. 14 and FIG. 15, the reflective LCD 502 may include a reflective liquid crystal display panel 302, a polarizing plate 450, and a λ/4 plate 460.

In some examples, the reflective liquid crystal display panel 302 may include the array substrate 100, the opposite substrate 200 facing the array substrate 100, and the blue-phase liquid crystal 150 interposed between the array substrate 100 and the opposite substrate 200.

The array substrate 100 may include the first base substrate 130 and a plurality of pixels provided on the first base substrate 130. Although a sectional structure for only one pixel is representatively depicted in FIG. 14 for the purpose of explanation, remaining pixels have a sectional structure similar to that of the represented pixel.

The array substrate 100 may further include a reflective layer 180 provided on the is gate insulating layer 150. The reflective layer 180 may be formed at the entire portion of the pixel area PA (see FIG. 12) to reflect the external light L2 incident through the opposite substrate 200.

The polarizing plate 450 can convert the external light L2 into a linear polarized light. The linear polarized light can be converted into a left circular polarized light by the λ/4 plate 460, and the left circular polarized light can be converted into a right circular polarized light by the blue-phase liquid crystal 150. Since the blue-phase liquid crystal 150 selectively reflects a light having the wavelength range of a visible light, a portion of the right circular polarized light can be incident onto the λ/4 plate 460. However, the right circular polarized lights incident onto the λ/4 plate 460 do not pass through the λ/4 plate 460, but are destructed. Accordingly, the light leakage caused by the external light L2 can be prevented.

The right circular polarized light, which is not reflected by the blue-phase liquid crystal 150, can be reflected by the reflective layer 180 and can be incident onto the blue-phase liquid crystal 150. The right circular polarized light, which is incident onto the blue-phase liquid crystal 150, can be converted into a left circular polarized light by the blue-phase liquid crystal 150, and the left circular polarized light can be converted into the linear circular polarized light by the λ/4 plate 460. The polarizing plate 450 can transmit the linear polarized light. Accordingly, a user can recognize the light reflected by the reflective layer 180.

Accordingly, the λ/4 plate 460 may be provided, thereby preventing the light leakage due to the selective reflective characteristic of the blue-phase liquid crystal 150 in the reflective LCD 502.

FIG. 16 is a sectional view showing a transflective LCD 503 according to exemplary embodiments of the present invention. The same reference numerals will be assigned is to elements of FIG. 16 identical to elements of FIG. 11 and FIG. 14, and details thereof may be omitted in order to avoid unnecessarily obscuring the invention.

Referring to FIG. 16, the transflective LCD 503 may include a transflective liquid crystal display panel 303, the first polarizing plate 410, the first λ/4 plate 420, the second λ/4 plate 430, and the second polarizing plate 440.

In some examples, the transflective liquid crystal display panel 302 may include the array substrate 100, the opposite substrate 200 facing the array substrate 100, and the blue-phase liquid crystal 150 interposed between the array substrate 100 and the opposite substrate 200.

The array substrate 100 may include the first base substrate 130 and a plurality of pixels provided on the first base substrate 130. Although a sectional structure for only one pixel is representatively depicted in FIG. 16 for the purpose of explanation, remaining pixels have a sectional structure similar to that of the represented pixel.

The array substrate 100 may further include a reflective layer 185 provided on the gate insulating layer 150. The reflective layer 185 may partially be formed on the pixel area PA (see FIG. 12) to reflect the external light L2 incident through the opposite substrate 200. In other words, an area, in which the reflective layer 185 is formed, may be defined as a reflective area, and an area, in which the reflective layer 185 is not formed, may be defined as a transmissive area to transmit the light L1 output from the backlight provided below the array substrate 100.

A cell gap in the transmissive area may be identical to a cell gap in the reflective area. However, the first pixel electrode 110 and the second pixel electrode 120 adjacent to each other in the transmissive area may be spaced apart from each other with a first interval d1, and the first pixel electrode 110 and the second pixel electrode 120 adjacent to each other in the is reflective area may be spaced apart from each other with a second interval d2 greater than the first interval d1. Due to the difference between the first interval d1 and the second interval d2, the intensity of the electric field in the transmissive area may be greater than the intensity of the electric field in the reflective area. Due to the difference in the intensity of the electric field between the transmissive and reflective areas, the refractive index of the blue-phase liquid crystal 150 positioned in the transmissive area may be greater than the refractive index of the blue-phase liquid crystal 150 positioned in the reflective area.

The difference in color reproduction between the transmissive and reflective areas, which occurs because a light twice passes through the color filter 160 in the reflective area, can be compensated.

For example, if the transflective LCD 503 operates in a transmissive mode, the light L1 output from the backlight provided below the liquid crystal display panel 301 can be converted into a linear polarized light by the second polarizing plate 440. The linear polarized light can be converted into a right circular polarized light by the second λ/4 plate 430, and the right circular polarized light can be converted into a left circular polarized light by the blue-phase liquid crystal 150. The left circular polarized light, which is passed through the blue-phase liquid crystal 150, can be incident onto the first λ/4 plate 420. The first λ/4 plate 420 can convert the left circular polarized light into a linear polarized light. The linear polarized light can be output to the outside through the first polarizing plate 410. Accordingly, the light output from the backlight can be viewed by the user.

For example, in the transmissive mode, the first polarizing plate 410 can convert the external light L2 into a linear polarized light. The linear polarized light can be converted into a left circular polarized light by the first λ/4 plate 420, and the left circular polarized light can be is converted into a right circular polarized light by the blue-phase liquid crystal 150 (see FIG. 11). Since the blue-phase liquid crystal 150 selectively reflects a light having the wavelength range of a visible light, a portion of the right circular polarized light can be incident onto the first λ/4 plate 420. However, the right circular polarized lights, which are incident onto the first λ/4 plate 420, do not pass through the first λ/4 plate 420, but are destructed. Accordingly, the light leakage caused by the external light L2 can be prevented.

For example, if the transflective LCD 503 operates in a reflective mode, the first polarizing plate 410 can convert the external light L2 into a linear polarized light. The linear polarized light is converted into a left circular polarized light by the first λ/4 plate 420, and the left circular polarized light is converted into a right circular polarized light by the blue-phase liquid crystal 150. Since the blue-phase liquid crystal 150 selectively reflects a light having the wavelength range of a visible light, a portion of the right circular polarized light can be incident onto the first λ/4 plate 420. However, the right circular polarized lights, which are incident onto the first λ/4 plate 420, do not pass through the first λ/4 plate 420, but are destructed. Accordingly, the light leakage caused by the external light L2 can be prevented.

The right circular polarized light, which is not reflected by the blue-phase liquid crystal 150, can be reflected by the reflective layer 185 and then incident onto the blue-phase liquid crystal 150. The right circular polarized light, which is incident onto the blue-phase liquid crystal 150, can be converted into a left circular polarized light by the blue-phase liquid crystal 150, and the left circular polarized light can be converted into a linear polarized light by the first λ/4 plate 420. The first polarizing plate 410 can transmit the linear polarized light. Accordingly, a user can view the light reflected by the reflective layer 185.

The first λ/4 plate 420 and second λ/4 plate 430 are provided, thereby preventing is the light leakage due to the selective reflective characteristic of the blue-phase liquid crystal 150 in both the transmissive mode and the reflective mode.

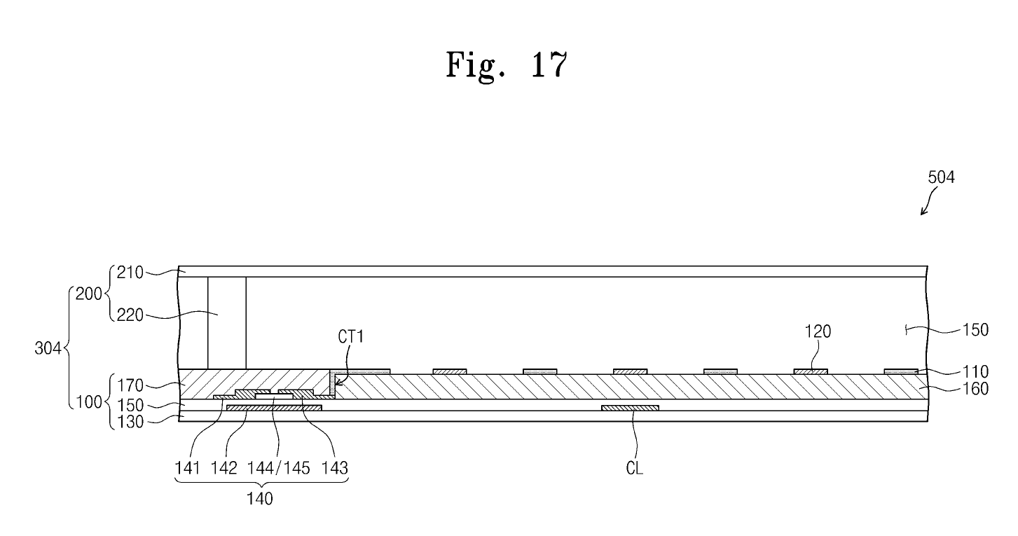

FIG. 17 is a sectional view showing a reflective LCD 504 according to exemplary embodiments of the present invention. The same reference numerals will be assigned to elements of FIG. 17 identical to elements of FIG. 14, and details thereof may be omitted in order to avoid unnecessarily obscuring the invention.

Referring to FIG. 17, the reflective LCD 504 may include a reflective liquid crystal display panel 304.

In some examples, the reflective liquid crystal display panel 304 may have the same structure as that of the reflective liquid crystal display panel 302 of FIG. 14 except that the reflective liquid crystal display panel 304 does not include the reflective layer 180. For example, since the reflective peak wavelength (λpeak) of the blue-phase liquid crystal 150 is positioned in the wavelength range of a visible light, the external light L2 may be reflected by the blue-phase liquid crystal 150. The reflective liquid crystal display panel 304 can display an image by using the light reflected by the blue-phase liquid crystal 150.

The reflectance of the blue-phase liquid crystal 150 may vary depending on the magnitudes of the first driving voltage and the second driving voltage applied to the first pixel electrode 110 and the second pixel electrode 120 of an appropriate pixel. For example, if the potential difference between the first and second driving voltages applied to the pixel is increased, the reflectance of the blue-phase liquid crystal 150 can be increased so that the pixel can represent high gray scales. In contrast, if the potential difference between the first and second driving voltages applied to the pixel is decreased, the reflectance of the blue-phase liquid crystal 150 can be decreased so that the pixel can represent low gray scales.

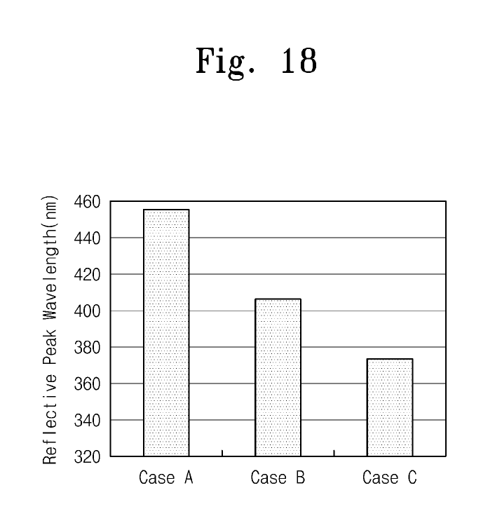

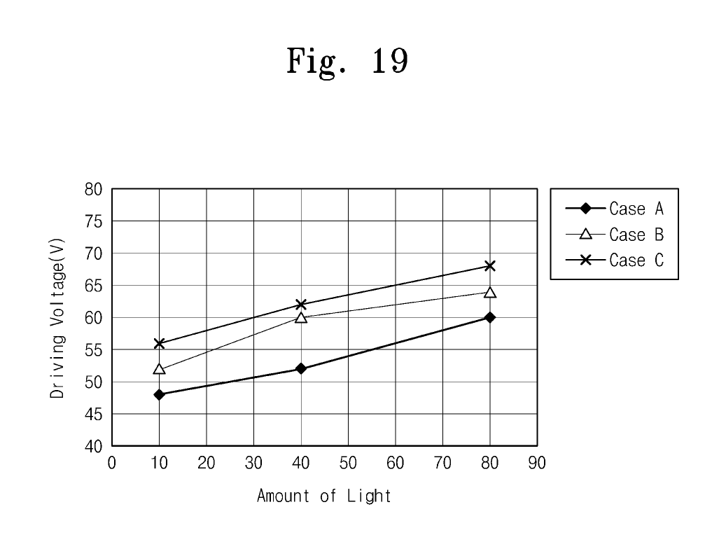

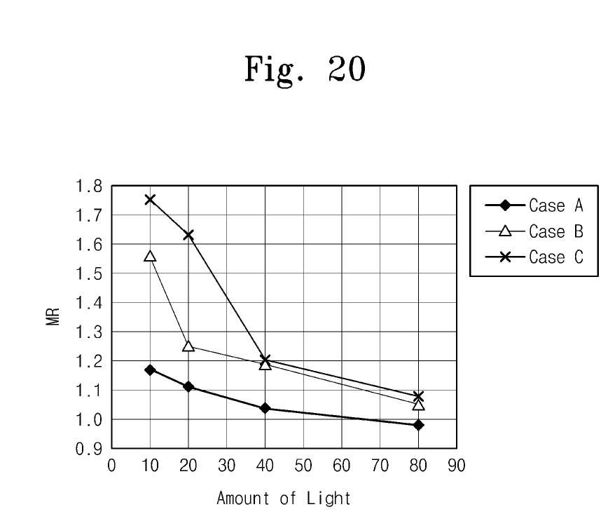

FIG. 18 is a graph showing a reflective peak wavelength as a function of an amount of chiral dopants, and FIG. 19 is a graph showing driving voltages according to the case A, the case B and the case C of FIG. 18. FIG. 20 is a graph showing a memory ratio according to the case A, the case B and the case C of FIG. 18.

Referring to FIG. 18, the case A, the case B and the case C may be classified according to an amount of chiral dopants doped into the blue-phase liquid crystal 150. According to exemplary embodiments of the present invention, the case A may have the greatest amount of chiral dopants among the case A, the case B and the case C, and the case C may have the least amount of chiral dopants among the case A, the case B and the case C.

As shown in FIG. 18, as an amount of chiral dopants is increased, the reflective peak wavelength (λpeak) can be increased. For example, while the reflective peak wavelength (λpeak) in the case A is represented as about 450 nm, the reflective peak wavelengths (λpeak) of the case A, the case B and the case C can be represented as about 400 nm and about 370 nm, respectively.

For example, the amount of chiral dopants doped into the blue-phase liquid crystal 150 is adjusted so that the reflective peak wavelength (λpeak) of the blue-phase liquid crystal 150 can be adjusted.

Referring to FIG. 19, the case A representing the reflective peak wavelength (λpeak) of about 450 nm may require the driving voltage (that is, voltage required to drive the blue-phase liquid crystal 150) lower than those of the cases B and the case C representing the reflective peak wavelengths (λpeak) of about 400 nm and about 370 nm, respectively. For example, as the reflective peak wavelength (λpeak) is increased, the driving voltage can be lowered regardless of an amount of a light.

Referring to FIG. 20, the case A representing the reflective peak wavelength (λpeak) of about 450 nm may have a memory ratio approximate to 1 lower than those of the case B and case C representing the reflective peak wavelengths (λpeak) of about 400 nm and about 370 nm, in which the memory ratio may represent a value obtained by dividing black brightness, which is represented after the driving of the liquid crystal display panel 300, by black brightness which is represented before the initial driving of the liquid crystal display panel 300.

The reflective peak wavelength (λpeak) of the blue-phase liquid crystal 150 can be adjusted by an amount of chiral dopants. If the reflective peak wavelength (λpeak) is shifted into the wavelength range of visible light by adjusting the amount of the chiral dopants, the driving voltage and the memory ratio can be reduced. Accordingly, display quality can be improved.

In this example, the λ/4 plate may be provided above or below the liquid crystal display panel 300, 301, 302, 303, or 304, thereby removing a visible light selectively reflected by the blue-phase liquid crystal 150. Accordingly, the light leakage caused by the visible light selectively reflected can be prevented.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display, comprising:
a first substrate comprising pixel areas to display an image;
a second substrate facing the first substrate;
a blue-phase liquid crystal interposed between the first substrate and the second substrate to selectively reflect a light having a wavelength range of about 400 nm to about 700 nm; and
a phase difference plate disposed above, below, or both above and below of the blue-phase liquid crystal.

2. The liquid crystal display of claim 1, wherein the blue-phase liquid crystal has a peak reflectance wavelength in a range of about 450 nm to about 550 nm.

3. The liquid crystal display of claim 2, wherein the blue-phase liquid crystal comprises liquid crystal molecules having a double-twisted cylinder structure by aligning liquid crystal directors in a double spiral structure, and the liquid crystal molecules have a body-centered cubic lattice structure.

4. The liquid crystal display of claim 3, wherein the reflective peak wavelength is calculated according to:
$$λ peak = \frac{2 na}{\sqrt{{h}^{2} + {k}^{2} + {l}^{2}}}$$
where, the λpeak represents the reflective peak wavelength, the n represents an average refractive index of the blue-phase liquid crystal, the a represents a length of each side of a cube defined by a body-centered cubic lattice, and the h, k, and l represent three integers belonging to miller indexes when each plane of the cube is expressed as the miller indexes.

5. The liquid crystal display of claim 4, wherein the a has a value in a range of about 210 nm to about 260 nm.

6. The liquid crystal display of claim 1, wherein the first substrate comprises:
a base substrate;
a first pixel electrode disposed on the base substrate and placed in each pixel area; and
a second pixel electrode disposed on the base substrate and being spaced apart from the first pixel electrode in each pixel area, the second pixel electrode to interact with the first pixel electrode to form an electric field.

7. The liquid crystal display of claim 6, wherein the phase difference plate comprises a first λ/4 plate disposed above the second substrate and a second λ/4 plate disposed above the first substrate, and
wherein the first λ/4 plate has a slow axis orthogonal to a slow axis of the second λ/4 plate.

8. The liquid crystal display of claim 7, further comprising:
a first polarizing plate disposed above the first λ/4 plate and a second polarizing plate provided below the second λ/4 plate,
wherein the first polarizing plate has a polarizing axis orthogonal to a polarizing axis of the second polarizing plate, and
wherein the first λ/4 plate has the slow axis inclined from the polarizing axis of the first polarizing plate at an angle of about +45°, and the second λ/4 plate has the slow axis inclined from the polarizing axis of the first polarizing plate at an angle of about −45°.

9. The liquid crystal display of claim 6, wherein the first substrate is disposed below the second substrate, and further comprises a reflective layer disposed on the base substrate to reflect a first light incident through a top surface of the second substrate.

10. The liquid crystal display of claim 9, wherein the phase difference plate comprises a λ/4 plate disposed above the second substrate.

11. The liquid crystal display of claim 10, further comprising:
a polarizing plate disposed above the λ/4 plate,
wherein the λ/4 plate has a slow axis inclined from a polarizing axis of the polarizing plate at an angle of about +45° or about −45°.

12. The liquid crystal display of claim 6, wherein each pixel area comprises a transmissive area and a reflective area, and
wherein the first substrate further comprises a reflective layer disposed on the base substrate corresponding to the reflective area to reflect a first light incident through a top surface of the second substrate, and disposed corresponding to the transmissive area to reflect a second light incident through a bottom surface of the first substrate.

13. The liquid crystal display of claim 12, wherein an interval between the first pixel electrode and the second pixel electrode in the reflective area is greater than an interval between the first electrode and the second electrode in the transmissive area.

14. The liquid crystal display of claim 13, wherein the liquid crystal display panel has the same cell gap in the transmissive area and the reflective area.

15. The liquid crystal display of claim 12, wherein the phase difference plate comprises a first λ/4 plate disposed above the second substrate, and a second λ/4 plate disposed below the first substrate, and
wherein the first λ/4 plate has a slow axis orthogonal to a slow axis of the second λ/4 plate.

16. The liquid crystal display of claim 15, further comprising:
a first polarizing plate disposed above the first λ/4 plate and a second polarizing plate disposed below the second λ/4 plate,
wherein the first polarizing plate has a polarizing axis orthogonal to a polarizing axis of the second polarizing plate, and
wherein the first λ/4 plate has a polarizing axis inclined from the polarizing axis of the first polarizing plate at an angle of about +45°, and the second λ/4 plate has a polarizing axis inclined from the polarizing axis of the first polarizing plate at an angle of about −45°.

17. A display, comprising:
a plurality of pixels disposed on a first substrate facing a second substrate, wherein a blue-phase liquid crystal is interposed between the first substrate and the second substrate,
wherein the blue-phase liquid crystal has a peak reflectance wavelength in a visible wavelength range from about 400 nm to about 700 nm to selectively reflect a light incident via a top surface of the second substrate.

18. The display of claim 17, wherein the peak reflectance wavelength is positioned in a range of about 450 nm to about 550 nm.

19. The display of claim 17, wherein the first substrate comprises:
a base substrate;
a first pixel electrode disposed on the base substrate and placed at each pixel area; and
a second pixel electrode disposed on the base substrate being spaced apart from the first pixel electrode in each pixel area, and the second pixel electrode to interact with the first pixel electrode to form an electric field.

20. The display of claim 19, wherein a reflectance of the blue-phase liquid crystal increases as a difference between two voltages applied to the first pixel electrode and the second pixel electrode increase.
